(19) United States
(12) Patent Application Publication
(10) Pub. No.: US 2016/0016457 A1
(43) Pub. Date: Jan. 21, 2016

(54) Cabin Air System

(71) Applicant: Caterpillar Inc., Peoria, IL (US)

(72) Inventors: Vincent Caliendo, Peoria, IL (US); Bryant Morris, Peoria, IL (US); Jeffrey Ries, Metamora, IL (US)

(73) Assignee: Caterpillar Inc., Peoria, IL (US)

(21) Appl. No.: 14/335,382

(22) Filed: Jul. 18, 2014

(51) Int. Cl. B60H 1/24; B60H 3/06; B60H 1/26

(52) U.S. Cl. CPC B60H 1/241; B60H 1/248; B60H 1/267; B60H 3/0658; B60H 3/0608

(57) ABSTRACT

A damper box includes a curved wall, an outlet, a side wall, and filter and a damper. The curved wall has an outside surface, an inside surface, and a separator sandwiched between an outside air inlet and a recirculated air inlet. The side wall is disposed between the recirculated air inlet and the outlet. The filter has a curvature matching the curved wall and covering the outside surface of the curved wall. The damper has an axis of rotation adjacent to and in alignment with the separator. The damper has a first face and a trailing edge. The first face is curved and configured to mate with a curved frame disposed about the outside air inlet. The trailing edge is configured to mate with the side wall. A ratio of outside air to recirculated air is modulated in response to the damper being rotated.

### TECHNICAL FIELD

This patent disclosure relates generally to a filter and damper box assembly and, more particularly, to a cabin air system for a cabin of a vehicle.

### BACKGROUND

Cabin air systems for vehicles are known to provide air conditioned air to the operators of the vehicle. In addition to heating and cooling, these cabin air systems generally include filtration of incoming outside air as well as recirculated air within the cabin. In general, these systems include two separate and different filtering systems. This is because filters for one environment are often different than filters for a different environment. As such, filters are often designed with a particular environment in mind.

Factors that may be evaluated when considering an environment include volume of air being filtered, particulate load, types of particulates, odor removal, other contaminants, humidity, and the like. However, in situations in which the filter system is exposed to more than one environment, compromises may be made or two separate filters may be used in a filter system. For example, cabin filter systems for vehicles typically include at least two filters with one filtering outside air and the other filtering air recirculated within the cabin. The differences between these filters may be particularly great for earth-moving vehicles due to the potentially high dust load in the outside air.

In addition, the cabins of these earth-moving vehicles are generally compact with minimal extra space available for damper boxes and ducting. As such, conventional filter systems are often placed in areas that are difficult to access and service. Unfortunately, without regular servicing, air quality within the cabin may be adversely affected. In addition, the motor for the blower and other components may be adversely affected. Furthermore, the added time to service separate filters increases down-time of the machine or vehicle.

Accordingly, there is a need for an improved filter system to address the problems described above and/or problems posed by other conventional approaches.

### SUMMARY

The foregoing needs are met, to a great extent, by aspects of the present disclosure; wherein in one respect a filter system is provided that in some aspects addresses the problems posed by other conventional approaches.

An aspect pertains to a damper box. The damper box includes a curved wall, an outlet, a side wall, and filter and a damper. The curved wall has an outside surface, an inside surface, and a separator sandwiched between an outside air inlet and a recirculated air inlet. The side wall is disposed between the recirculated air inlet and the outlet. The filter has a curvature matching the curved wall and covering the outside surface of the curved wall. The damper has an axis of rotation adjacent to and in alignment with the separator. The damper has a first face and a trailing edge. The first face is curved and configured to mate with a curved frame disposed about the outside air inlet. The trailing edge is configured to mate with the side wall. A ratio of outside air to recirculated air is modulated in response to the damper being rotated.

Another aspect pertains to a damper box. The damper box includes a curved wall, an outlet, a side wall, and filter and a damper. The curved wall has an outside surface, an inside surface, and a separator sandwiched between an outside air inlet and a recirculated air inlet. The side wall is disposed between the recirculated air inlet and the outlet. The filter has a curvature matching the curved wall and covering the outside surface of the curved wall. The damper has an axis of rotation adjacent to and in alignment with the separator. The damper has a first face and a trailing edge. The first face is curved and configured to mate with a curved frame disposed about the outside air inlet. The trailing edge is configured to mate with the side wall. A ratio of outside air to recirculated air is modulated in response to the damper being rotated.

Yet another aspect relates to a damper box. The damper box includes a top portion, bottom portion, curved wall, side wall, and an outlet. Both the top portion and the bottom portion are pie shaped as defined by a curved edge, a first straight edge and a second straight edge. The first and second straight edges each have an end meeting at an angle and each straight edge has another end meeting respective ends of the curved edge. The curved wall has a curved top edge joined to the curved edge of the top portion and the curved wall has a curved bottom edge joined to the curved edge of the bottom portion. The curved wall has an outside surface and an inside surface. The curved wall includes a separator sandwiched between an outside air inlet and a recirculated air inlet. The side wall has a first side edge joined to a first side edge of the curved wall. The side wall has a top edge joined to the first straight edge of the top portion. The side wall has a bottom edge joined to the first straight edge of the bottom portion. The outlet is defined by a second side edge of the curved wall, the second edge of the top portion, the second edge of the bottom portion, and a second side edge of the side wall.

Yet another aspect relates to a filter. The filter includes a substrate and a filter media. The substrate has a length and a width. The length is defined by an arcuate curvature and the width is uniform along the length of the substrate. The filter media is disposed upon a first side of the substrate and conforms to the substrate. A first portion of the filter media is configured to filter outside air for a cabin air system of a vehicle. A second portion of the filter media is configured to filter recirculated air of the cabin air system.

Yet another aspect relates to a cabin air system. The cabin air system includes a blower, a damper box, an actuator, and a controller. The blower generates a flow of air. The damper box includes a curved wall, an outlet, a side wall, and a damper. The curved wall has an outside surface, an inside surface, and a separator sandwiched between an outside air inlet and a recirculated air inlet. The side wall is disposed between the recirculated air inlet and the outlet. The damper has an axis of rotation adjacent to and in alignment with the separator. The damper has a first face and a trailing edge. The first face is curved and configured to mate with a curved frame disposed about the outside air inlet. The trailing edge is configured to mate with the side wall. A ratio of outside air to recirculated air is modulated in response to the damper being rotated. The actuator is configured to rotate the damper about the axis. The controller is configured to control the blower and the actuator.

Yet another aspect relates to a cabin air system. The cabin air system includes a blower, a damper box, and a controller. The blower generates a flow of air. The damper box includes a top portion, bottom portion, curved wall, side wall, and an outlet. Both the top portion and the bottom portion are pie shaped as defined by a curved edge, a first straight edge and a second straight edge. The first and second straight edges each have an end meeting at an angle and each straight edge has another end meeting respective ends of the curved edge. The curved wall has a curved top edge joined to the curved edge of the top portion and the curved wall has a curved bottom edge joined to the curved edge of the bottom portion. The curved wall has an outside surface and an inside surface. The curved wall includes a separator sandwiched between an outside air inlet and a recirculated air inlet. The side wall has a first side edge joined to a first side edge of the curved wall. The side wall has a top edge joined to the first straight edge of the top portion. The side wall has a bottom edge joined to the first straight edge of the bottom portion. The outlet is defined by a second side edge of the curved wall, the second edge of the top portion, the second edge of the bottom portion, and a second side edge of the side wall. The controller controls the blower.

Yet another aspect relates to a method of filtering cabin air of a vehicle. In this method, a flow of air through a damper box is generated and a ratio of outside air to recirculated air is modulated. The flow of air through the damper box is generated with a blower. The damper box includes a top portion, bottom portion, curved wall, side wall, and an outlet. Both the top portion and the bottom portion are pie shaped as defined by a curved edge, a first straight edge and a second straight edge. The first and second straight edges each have an end meeting at an angle and each straight edge has another end meeting respective ends of the curved edge. The curved wall has a curved top edge joined to the curved edge of the top portion and the curved wall has a curved bottom edge joined to the curved edge of the bottom portion. The curved wall has an outside surface and an inside surface. The curved wall includes a separator sandwiched between an outside air inlet and a recirculated air inlet. The side wall has a first side edge joined to a first side edge of the curved wall. The side wall has a top edge joined to the first straight edge of the top portion. The side wall has a bottom edge joined to the first straight edge of the bottom portion. The outlet is defined by a second side edge of the curved wall, the second edge of the top portion, the second edge of the bottom portion, and a second side edge of the side wall. The ratio of outside air to recirculated air in the flow of air is modulated with a damper. The damper has an axis of rotation adjacent to and in alignment with the separator. The damper has a first face and a trailing edge. The first face is curved and configured to mate with a curved frame disposed about the outside air inlet. The trailing edge is configured to mate with the side wall. The ratio of outside air to recirculated air is modulated in response to the damper being rotated.

There has thus been outlined, rather broadly, certain aspects of the disclosure in order that the detailed description thereof herein may be better understood, and in order that the present contribution to the art may be better appreciated. There are, of course, additional aspects that will be described below and which will form the subject matter of the claims appended hereto.

In this respect, before explaining at least one example in detail, it is to be understood that the disclosure is not limited in its application to the details of construction and to the arrangements of the components set forth in the following description or illustrated in the drawings. The disclosed device and method is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the various aspects. It is important, therefore, that the claims be regarded as including such equivalent constructions insofar as they do not depart from the spirit and scope of the various aspects.

### BRIEF DESCRIPTION OF THE DRAWINGS

FIG. 1 is a perspective view illustrating an exemplary machine, according to an aspect of the disclosure.

FIG. 2 is a block diagram of a cabin air system according to an aspect of the disclosure.

FIG. 3 is a perspective view of a damper box according to an aspect of the disclosure.

FIG. 4 is a perspective view of a damper according to FIG. 3.

FIG. 5 is a perspective view of a filter according to FIG. 3.

FIG. 6 is a perspective view of a filter cover according to FIG. 3.

FIG. 7 is another perspective view of damper box according to FIG. 3.

FIG. 8 is a cutaway perspective view of a damper box according to another aspect of the disclosure.

FIG. 9 is a cutaway perspective view of the damper box with the filter installed according to FIG. 8.

FIG. 10 is a simplified cross sectional view showing the movement of the damper in the damper box according to FIG. 3.

FIG. 11 is a simplified cross sectional view showing the movement of the damper in the damper box according to another aspect of the disclosure.

### DETAILED DESCRIPTION

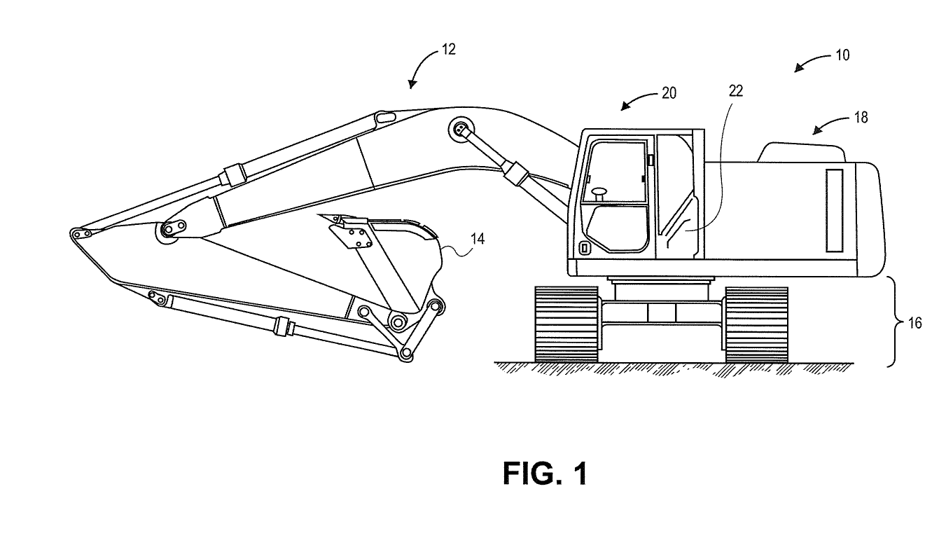

FIG. 1 illustrates an exemplary machine 10 having various systems and components that cooperate to accomplish a task. The machine 10 may embody a fixed or mobile machine that performs some type of operation associated with an industry such as mining, construction, farming, transportation, power generation, or another industry known in the art. For example, the machine 10 may be an earth moving machine such as an excavator (shown in FIG. 1), a dozer, a loader, a backhoe, a motor grader, a dump truck, or another earth moving machine. In addition, the machine may include any suitable watercraft and/or aircraft. Furthermore, although specific examples of the cabin air system being disposed within vehicles is made herein, the cabin air system may also be suitable for stationary structures. In the particular example shown in FIG. 1, the machine 10 may include an implement system 12 configured to move a work tool 14, a drive system 16 for propelling the machine 10, a power source 18.

The machine 10 also includes a cabin 20. The cabin 20 is configured to provide an operator of the machine 10 with a conducive environment in which to control the machine 10. For example, the machine 10 may include a cabin air system 22 configured to provide filtered, temperature regulated, and/or humidity regulated air. More particularly, the cabin air system 22 may provide the operator with outside or recirculated air that has passed through a filter media. As air passes through the filter media, contaminants such as dirt, debris, and the like are filtered out and collect in the filter media or an assembly that includes the filter media such as a filter (described further herein). Periodically, the filter is inspected to determine if it should be replaced. For example, if sufficient debris has collected on the filter, the filter may be replaced.

In conventional cabin air systems, there are two filters. One filter is used to filter outside air and it is generally accessed from outside the machine 10. The other filter is used to filter recirculating air and it is generally located inside the cabin. Unfortunately, this inside filter is often difficult to access and may be neglected.

The cabin air system 22 described herein overcomes these issues by including a single filter that filters both outside and recirculating air. It is a further advantage of the cabin air system 22 that outside air is directed to flow through a portion of the filter that is configured to filter outside air and that recirculated air is directed to flow through a portion of the filter that is configured to filter recirculated air. Additionally, it may be advantageous that the cabin air system 22 may be relatively compact and easier to place within the cabin 20. As described herein, it is an advantage of aspects of the cabin air system 22 that the filter is easy to access and, because it is a single unit, both the outside air filter and recirculated air filter are changed at once. This reduces maintenance time and effort and reduces the possibility that one filter may be neglected.

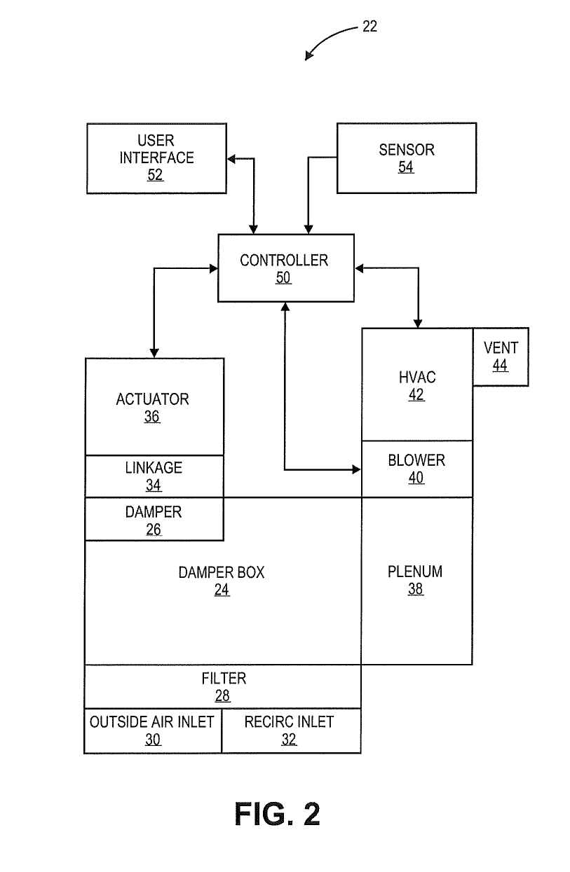

FIG. 2 is a block diagram of the cabin air system 22 according to an aspect of the disclosure. As shown in FIG. 2, the cabin air system 22 includes a damper box 24 with a damper 26 disposed therein. A filter 28 is disposed in fluid communication with the damper box 24. An outside air inlet 30 and a recirculated air inlet 32 are disposed in fluid communication with the filter 28. A linkage 34 is optionally disposed between the damper 26 and an actuator 36. If present, the linkage 34 is configured to convey movement of the actuator 36 to the damper 26. However, in some examples, the actuator 36 may be directly attached to the damper 26 and the linkage 34 may be omitted.

To continue, the cabin air system 22 optionally includes a conduit or plenum 38 to convey air from the damper box 24 to a blower 40 or a heating, ventilation, air conditioning unit (HVAC) unit 42. Although shown disposed between the damper box 24 and the blower 40, in other examples, the plenum 38 may be configured to fluidly couple any of the various components of the cabin air system 22 or may be omitted. The HVAC unit 42 may include any suitable device(s) or unit(s) configured to heat and/or cool a flow of air.

To direct a flow of the conditioned air, the cabin air system may include a vent 44. As is generally known, vents such as the vent 44 may include louvers or other such devices to modulate the direction and/or amount of air flow. In addition, while one vent is shown in FIG. 2, the cabin air system 22 may include any suitable number of the vent 44.

A controller 50 may be configured to control some or all of the components of the cabin air system 22. For example, the controller 50 may be configured to control the actuator 36 and thereby modulate the damper 26. As described herein, by modulating the damper 26 a ratio of outside air to recirculated air may be controlled. The controller 50 may also be configured to control the blower 40. For example, the controller 50 may be operable to modulate an amount of power being delivered to the blower 40. In this manner, the blower 40 may be turned off, turned on, and/or vary the speed at which the blower 40 rotates. Furthermore, the controller 50 may be configured to control an amount of heating and/or cooling generated by the HVAC unit 42.

A user interface 52 is included in the cabin air system 22 to provide the operator with the ability to communicate with the controller 50. For example, in response to the operator selecting an ‘On’ icon or button, the controller 50 may power the blower 40 to generate a flow of the air. In addition, the controller 50 may control the HVAC unit 42 to heat or cool the air based on a measurement by a sensor 54 in comparison to a desired temperature entered into the user interface 52. The user interface 52 may also provide the operator with the ability to control the ratio of outside air to recirculated air. For example, in response to operator input into the user interface 52, the controller 50 may control the actuator 36 to move. This movement may be translated via the linkage 34 to the damper 26.

In other examples, the controller 50 may automatically control the cabin air system 22 based on measurement obtained via the sensor 54. For example, if a sensed humidity is above a predetermined maximum humidity, the HVAC unit 42 may be controlled to supply both cooling and heating to remove moisture from the air. In this regard, the sensor 54 may be configured to sense any suitable environmental factor such as, for example, temperature, humidity, light, and the like.

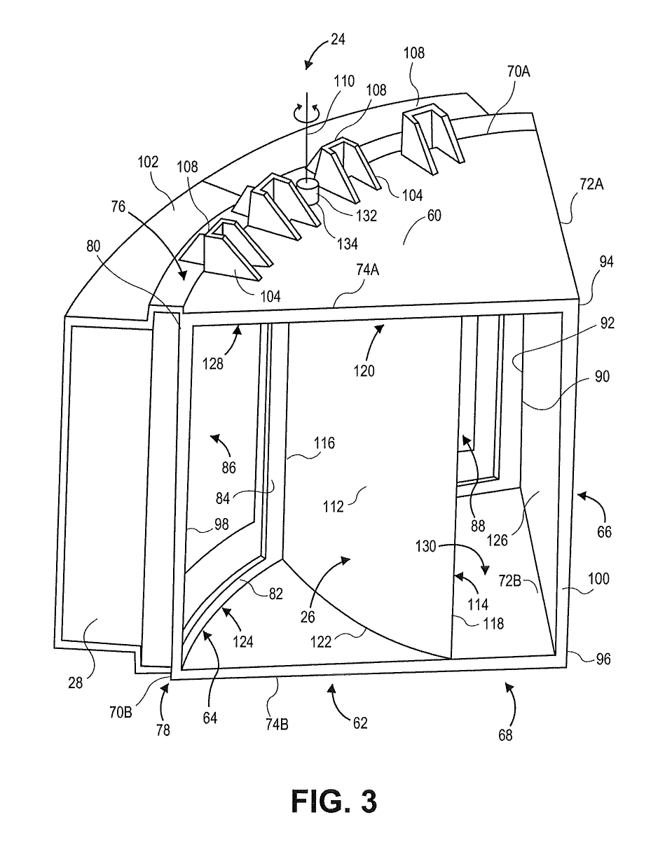

FIG. 3 is a perspective view of the damper box 24 according to an aspect of the disclosure. As shown in FIG. 3, the damper box 24 includes a top portion 60, a bottom portion 62, a curved wall 64, a side wall 66, and an outlet 68. Both the top portion 60 and the bottom portion 62 are pie shaped. The top portion 60 includes a curved edge 70A, a first straight edge 72A and a second straight edge 74A. The first straight edge 72A and the second straight edge 74A each have an end meeting at an angle and another end meeting respective ends of the curved edge 70A. The bottom portion 62 includes a curved edge 70B, a first straight edge 72B and a second straight edge 74B. The first straight edge 72B and the second straight edge 74B each have an end meeting at an angle and another end meeting respective ends of the curved edge 70B. The curved wall 64 has a curved top edge 76 joined to the curved edge 70A of the top portion 60 and the curved wall 64 has a curved bottom edge 78 joined to the curved edge 70B of the bottom portion 62. The curved wall 64 has an outside surface 80 and an inside surface 82. The curved wall 64 includes a separator 84 sandwiched between an outside air inlet 86 and a recirculated air inlet 88. The side wall 66 has a first side edge 90 joined to a first side edge 92 of the curved wall 64. The side wall 66 has a top edge 94 joined to the first straight edge 72A of the top portion 60. The side wall 66 has a bottom edge 96 joined to the first straight edge 72B of the bottom portion 62. The outlet 68 is defined by a second side edge 98 of the curved wall 64, the second straight edge 74A of the top portion 60, the second straight edge 74B of the bottom portion 62, and a second side edge 100 of the side wall 66.

In the particular example shown, the angle the first straight edge 72A and the second straight edge 74A meet at is 90°. However, in other examples, the angle may be greater or less that 90°. For example, the angle may be 30°, 45°, 60°, 120° or the like. To some extent, the angle may depend on the configuration of the cabin 20 shown in FIG. 1 and, as such, may be modified to suit the particular cabin 20.

Also shown in FIG. 3, the filter 28 is disposed upon and covers the curved wall 64. More particularly, the filter 28 covers the outside air inlet 86 and the recirculated air inlet 88. A filter cover 102 may be configured to retain the filter 28 upon the damper box 24. In various examples, the filter cover 102 may be an integral component of the damper box 24 or releaseably fastened to the damper box 24. In examples in which the filter cover 102 is an integral component of the damper box 24, the filter cover 102 may be formed as a single unit with the damper box 24 or the two components may be formed separately and adhesively secured, friction welded, or the like. In examples in which the filter cover 102 is releaseably fastened to the damper box 24, any suitable fastener may be utilized. Examples of suitable fasteners include screws, hole and prong, tab and slot fasteners, clips, clasps, or the like. In the particular example shown in FIG. 3, fittings such as a plurality of lugs 104 extend from the damper box 24 along the curved wall 64. Each of the lugs 104 is configured to mate with a corresponding set of prongs 108 extending from the filter cover 102 (shown more clearly in FIG. 6).

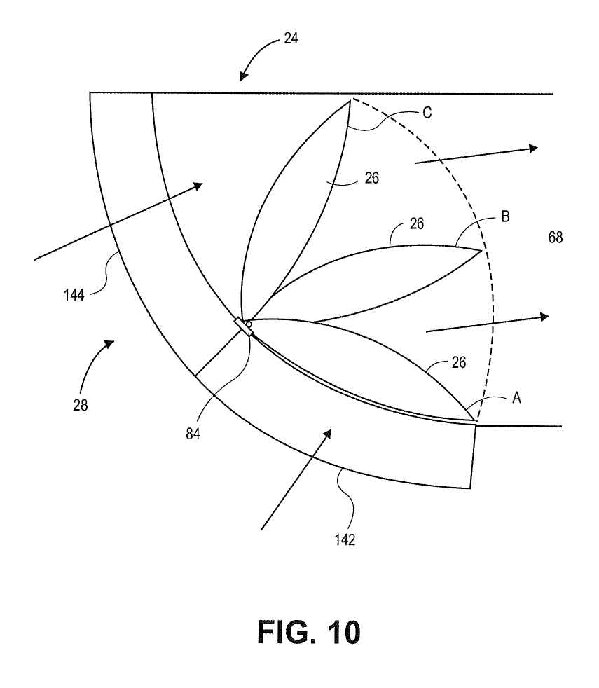

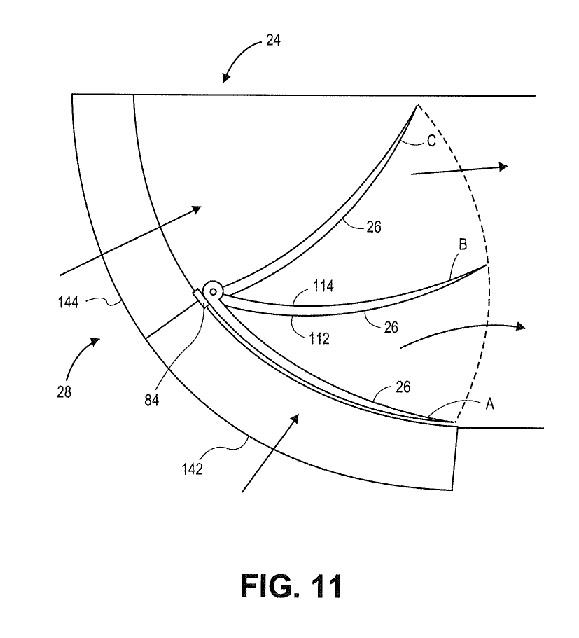

The damper 26 is disposed within the damper box 24. The damper 26 includes an axis of rotation 110 that adjacent to and in alignment with the separator 84 (shown also in FIGS. 10 and 11). The damper 26 has a first face 112, a second face 114, a leading surface 116, a trailing edge 118, a top edge 120, and a bottom edge 122.

The first face 112 is configured to mate with a frame 124 disposed about the outside air inlet 86 (shown in greater detail in FIGS. 10 and 11). That is, the first face 112 is curved to match the curvature of the frame 124 disposed on the curved wall 64. When the first face 112 is mated to the frame 124, the damper 26 acts to at least partially close the outside air inlet 86 (shown in greater detail in FIGS. 10 and 11). Optionally, to improve a seal between the first face 112 and the frame 124, one or both of these mating surfaces may include a sealing material such as, for example, reticulated foam, elastomeric material, or the like. In some examples, the damper 26 may be configured to completely seal the outside air inlet 86 when the first face 112 is mated to the frame 124. However, in other examples, the damper 26 may be configured to remain at least partially open to facilitate at least some outside air passing through the outside air inlet 86. In addition, having at least some outside air entering the cabin 20 may act to maintain a positive pressure within the cabin 20 and may facilitate reducing a buildup of vapors and the like.

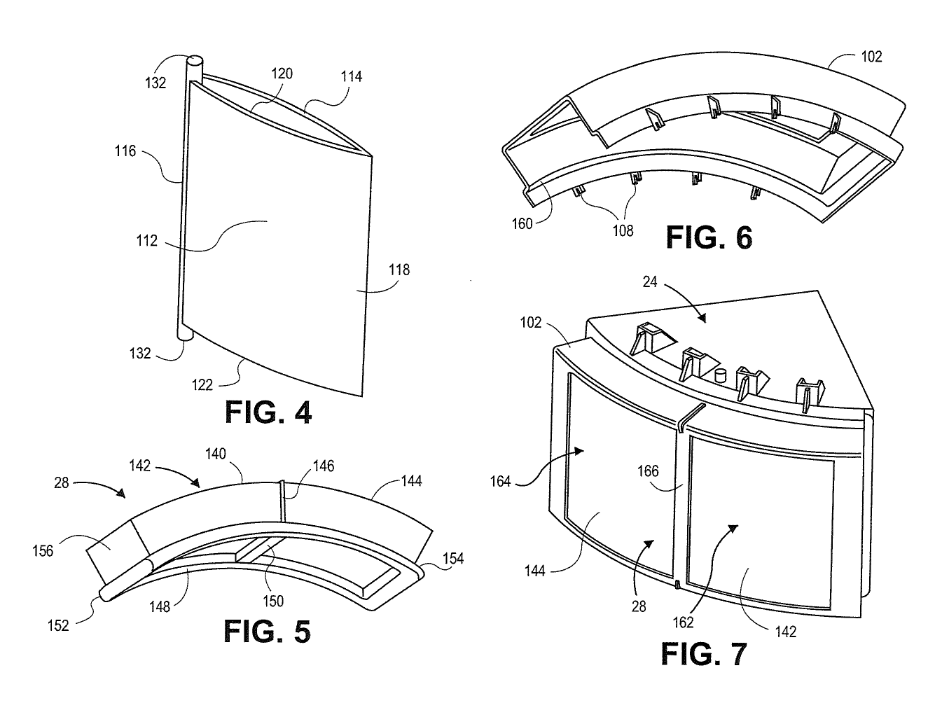

In an example, the second face 114 includes a mirror opposite curve (shown in FIG. 4) and together, the first face 112 and the second face 114 form a foil shape that improves aerodynamic performance of the damper 26 in the flow of air within the damper box 24.

The leading surface 116 is rounded such that as the damper 26 is rotated, contact or a slight gap is maintained between the leading surface 116 and the separator 84. This is shown in greater detail in FIGS. 10 and 11.

The trailing edge 118 is configured to mate with a side surface 126 of the damper box 24 (shown in greater detail in FIGS. 10 and 11). When the trailing edge 118 is mated to the side surface 126, the damper 26 acts to at least partially close the recirculated air inlet 88 (shown in greater detail in FIGS. 10 and 11). In some examples, the damper 26 may be configured to completely seal the recirculated air inlet 88 when the trailing edge 118 is mated to the side surface 126. However, in other examples, the damper 26 may be configured to remain at least partially open to facilitate at least some recirculated air passing through the recirculated air inlet 88. In this manner, rotation of the damper 26 may modulate a ratio of outside air to recirculated air.

However, in yet other examples, the damper box 24 may be configured such that the damper 26 may fully swing so that the second face 114 engages and covers the recirculated air inlet 88. In these examples, the trailing edge 118 need not be configured to mate with the side surface 126, but rather, the side surface 126 may include a protrusion sufficient to facilitate the swing of the damper 26.

The top edge 120 is in sliding engagement with a top surface 128 or may include a small gap between the top edge 120 and the top surface 128. Similarly, the bottom edge 122 is in sliding engagement with a bottom surface 130 or may include a small gap between the bottom edge 122 and the bottom surface 130. These sliding engagements or small gaps act to reduce the flow of air above and below the damper 26. By pivoting the damper 26 back and forth, the ratio of outside air to recirculated air may be adjusted. In this regard, the damper 26 includes a shaft 132 extending above the top edge 120 and below the bottom edge 122. The shaft 132 is configured to pivotally mate with a bore 134 disposed in the top portion 60 and a corresponding bore 134 disposed in the bottom portion 62.

FIG. 4 is a perspective view of the damper 26 according to FIG. 3. As shown in FIG. 4, the second face 114 may be a mirror image of the first face 112. Together, the first face 112 and the second face 114 may form a teardrop shape that facilitates smooth airflow across the damper 26. Also shown in FIG. 4, the shaft 132 extends both above the top edge 120 and below the bottom edge 122.

FIG. 5 is a perspective view of the filter 28 according to FIG. 3. As shown in FIG. 5, the filter 28 has a curvature matching the curved wall 64 and at least partially covers the outside surface of the curved wall 64. The filter 28 includes a filter media 140. A first or outside air portion 142 of the filter media 140 is configured to filter outside air for the cabin air system 22. A second or recirculated air portion 144 of the filter media 140 is configured to filter recirculated air of the cabin air system 22. Depending on the anticipated environment, the outside air portion 142 may be optimized to filter particulate matter such as dust. Likewise, the recirculated air portion 144 may be configured to reduce odors as well as dust, for example.

A divider 146 is disposed between the outside air portion 142 and the recirculated air portion 144 and configured to reduce an amount of fluid exchange between the outside air portion 142 and the recirculated air portion 144. In various examples, the divider 146 may include an air impermeable layer or membrane and/or the divider 146 may be formed by gluing two or more pleats of the filter media 140 together with an adhesive. In addition, the divider 146 may be configured to seal against the inside of the filter cover 102. In various examples, the divider 146 may include a urethane or other such elastomeric gasket, a foam strip, or other such sealing material disposed about the perimeter of the divider 146.

A gasket 148 is disposed on the convex side of the filter media 140 to form a seal with the outside surface of the curved wall 64. The gasket 148 includes a cross-member 150 in cooperative alignment with the divider 146 as well as the separator 84. Together, these elements provide a barrier to the exchange of outside and recirculated air. The gasket 148 further includes a lip 152 that extends out from the perimeter of the filter media 140.

Optionally, the filter 28 includes a substrate 154 sandwiched between the filter media 140 and the gasket 148. If included, the filter media 140 is disposed upon and conforms to the substrate 154 and the substrate 154 is configured to provide the curved shape to the filter 28. In general, the substrate 154 may be defined by a curve along the length and the width may be relatively flat or uniform along the length of the substrate 154. In various examples, the substrate may include a polymer, fiberboard, metal, or the like. However, in other examples, the filter media 140 and/or the gasket 148 may provide the curvature to the filter 28. In yet other examples, the filter 28 may be flexible and configured to bend to the curvature of the curved wall 64.

Optionally, the filter 28 includes an end piece 156 configured to seal the end of the filter 28 or otherwise reduce an influx of air from the side of the filter 28. In some examples, the end piece 156 may include a plastic wall, glue impregnated filter media, or the like. However, in other examples, the filter cover 102 may cover the end of the filter 28 or the end piece 156 may be otherwise omitted.

FIG. 6 is a perspective view of a filter cover 102 according to FIG. 3. As shown in FIG. 6, the filter cover 102 includes the prongs 108 to releaseably secure the filter cover 102 to the damper box 24. Also shown in FIG. 6, the filter cover 102 includes a lip 160 configured to mate with the lip 152 of the filter 28. In response to the filter cover 102 being installed on the filter 28, the lip 160 is configured to engage the lip 152 and urge the gasket 148 towards the curved wall 64. In this manner, the lip 152 is urged against the curved wall 64 to form a seal.

FIG. 7 is another perspective view of the damper box 24 according to FIG. 3. As shown in FIG. 7, the filter cover 102 includes an outside air opening 162 and a recirculation air opening 164. The outside air opening 162 is disposed in cooperative alignment with the outside air portion 142 of the filter 28. The recirculation air opening 164 is disposed in cooperative alignment with the recirculated air portion 144 of the filter 28. The filter cover 102 also includes a divider 166 disposed in cooperative alignment with the divider 146 of the filter 28. In response to the filter cover 102 being installed over the filter 28, the divider 166 urges the divider 146 towards the curved wall 64. In turn, the divider 146 urges the cross-member 150 of the gasket 148 into the separator 84 of the damper box 24 to form a seal between the two sides of the filter 28 and the damper box 24.

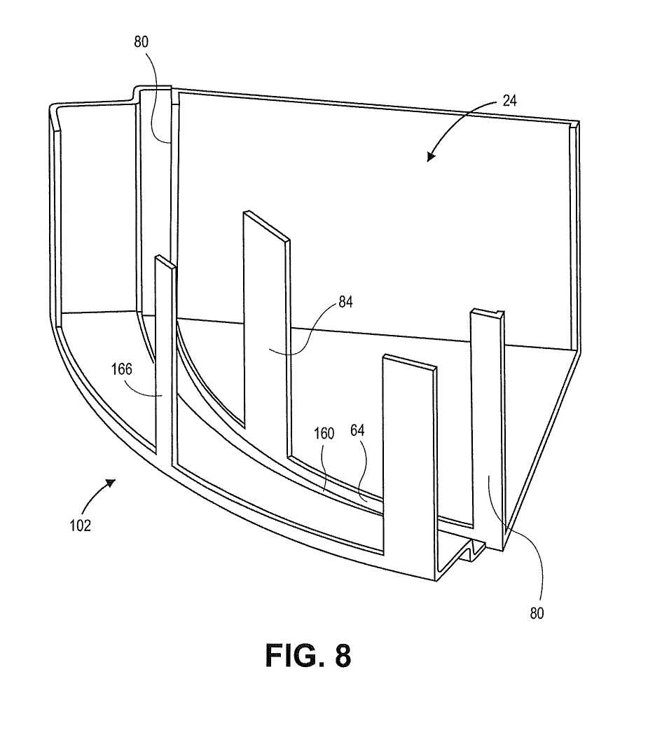

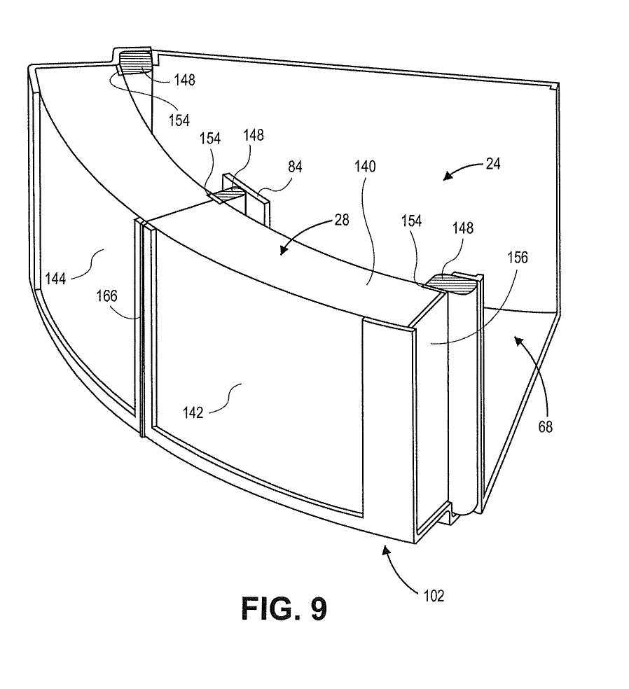

FIG. 8 is a cutaway perspective view of a damper box 24 according to another aspect of the disclosure. As shown in FIG. 8, the various inside surfaces of the filter cover 102 are each in cooperative alignment with corresponding outside surfaces of the curved wall 64. Particular examples of these cooperatively aligned surfaces include the separator 84/the divider 166 and the lip 160/curved wall 64. These aligned surfaces act to compress the gasket 148 and form a seal between the filter 28 and the damper box 24 (as shown in FIG. 9).

FIG. 9 is a cutaway perspective view of the damper box 24 with the filter 28 installed according to FIG. 8. As shown in FIG. 9, the gasket 148 is urged to seal against the curved wall 64 in response to the cooperatively aligned surfaces between the filter cover 102 and the damper box 24.

FIG. 10 is a simplified cross sectional view showing the movement of the damper 26 in the damper box 24 according to FIG. 3. As shown in FIG. 10, as the damper 26 is rotated from position “A” through position “B” and to position “C”, the ratio of outside air to recirculated air is modulated. For example, position A may prevent or allow for a minimal amount of outside air to enter the damper box 24. Position B may facilitate about a 50::50 outside air::recirculated air ratio. Position C may prevent or allow a minimal amount of recirculated air into the damper box 24. In a particular example, in response to the operator selecting a maximum amount of outside air, the controller shown in FIG. 2 may control the damper 26 to rotate into position C. In response to the operator selecting a minimum amount of outside air, the controller shown in FIG. 2 may control the damper 26 to rotate into position A.

FIG. 11 is a simplified cross sectional view showing the movement of the damper 26 in the damper box 24 according to another aspect of the disclosure. FIG. 11 is similar to FIG. 10 and thus, for the sake of brevity, those elements described in FIG. 10 will not be described again. Of note, the outside air portion 142 of the filter 28 is significantly larger than the recirculated air portion 144 of the filter 28 and the second face 114 is concave rather than being a convex surface.

With respect to the relative size and/or composition of the filter 28, these features of the filter 28 may be varied in any suitable manner. For example, if empirical data, experimentation, and/or it is otherwise anticipated that the machine 10 will be operated in an environment where increased filtering capacity would be beneficial, the outside air portion 142 of the filter 28 may be made significantly larger than the recirculated air portion 144 of the filter 28. Alternatively, if empirical data, experimentation, and/or it is otherwise anticipated that the machine 10 will be operated in an environment where the air will be primarily recirculated, the recirculated air portion 144 of the filter 28 may be made significantly larger than the outside air portion 142 of the filter 28.

With respect to the shape of the second face 114, because the second face does not interact with a surface to modulate the flow of recirculated air, the second face 114 can be any suitable shape. For example, the second face 114 may be concave shaped to reduce the weight of the damper 26.

### INDUSTRIAL APPLICABILITY

The present disclosure may be applicable to any machine including a cabin air system. Aspects of the disclosed cabin air system may promote ease of manufacture, ease of filter maintenance, operational flexibility, and improved filtration performance.

Applicants discovered that by combining the outside air filter and the recirculated air filter into a single filter having two separate areas for the different air flows, a variety of improvements could be realized. Examples of these improvements include a reduction in the size and complexity of the cabin air system, ease of servicing the filter, reduction in filter inventory, greater compliance in changing the recirculated air filter, and the like. In particular the ease of servicing the filter offers a great improvement over systems in which the two filters are in different locations and particularly where the recirculated air filter is in a difficult to access portion of the cabin interior.

According to an aspect of the disclosure shown in FIG. 3, the damper box 24 is an elegant and uncomplicated solution to providing outside and recirculated air to the cabin air system 22. In particular, the damper box 24 is smaller than conventional system and may be more easily placed in the cabin 20. Also, the curved shape of the filter 28 provides for a relatively longer filter than could be accommodated by a straight filter connecting the two straight sides of the damper box 24. This increased length of the filter 28, relative to the other dimensions of the damper box 24, provides an increased area for the filter media 140. The damper box 24 also facilitates a reduced amount of ducting to convey the outside and recirculated air to the damper box 24.

In addition, the damper box 24 is an elegant and uncomplicated solution to modulating the ratio of outside air to recirculated air in the cabin air system 22. For example, the curved shape of the first face 112 of the damper 26 matches the curvature of the frame 124. The frame 124 is curved to match the curve of the filter 28. However, this curvature in the first face 112 provides an aerodynamic surface that facilitates a smooth flow of air relative to a flat surface. In addition, it is an advantage that the trailing edge 118 is used to modulate the flow of recirculated air through the damper box 24 because this reduces the size of the damper box 24 and it reduces the amount of rotation of the damper 26. These improvements are made while reducing the number of filters in the cabin air system 22 and without using a filter media that may be a compromise between an outside air filter and a recirculated air filter. That is, the type and conformation of the filter media and the surface area of these two filtering areas on the single filter may be optimized for the particular filtering task. Thus, instead of incurring greater complexity and/or operating costs to achieve these improvements, the damper box 24 simplifies manufacture of replacement filters.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified. The many features and advantages of the various aspects are apparent from the detailed specification, and thus, it is intended by the appended claims to cover all such features and advantages that fall within the true spirit and scope of the aspects. Further, since numerous modifications and variations will readily occur to those skilled in the art, it is not desired to limit the aspects to the exact construction and operation illustrated and described, and accordingly, all suitable modifications and equivalents may be resorted to, falling within the scope of the various aspects.

We claim:

1. A cabin air system, comprising:
a blower to generate a flow of air;
a damper box including:
a curved wall having an outside surface and an inside surface, the curved wall including a separator sandwiched between an outside air inlet and a recirculated air inlet;
an outlet;
a side wall disposed between the recirculated air inlet and the outlet; and
a damper having an axis of rotation adjacent to and in alignment with the separator, the damper having a first face and a trailing edge, the first face being curved and configured to mate with a curved frame disposed about the outside air inlet, the trailing edge being configured to mate with the side wall, wherein a ratio of outside air to recirculated air is modulated in response to the damper being rotated;
an actuator configured to rotate the damper about the axis of rotation; and
a controller configured to control the blower and the actuator.

2. The cabin air system according to claim 1, further comprising:
a filter having a curvature matching the curved wall and covering the outside surface of the curved wall, the filter including:
an outside air portion configured to filter outside air; and
a recirculated air portion configured to filter recirculated air.

3. The cabin air system according to claim 2, further comprising:
a divider disposed in the filter between the outside air portion and the recirculated air portion and configured to reduce an amount of fluid exchange between the outside air portion and the recirculated air portion.

4. The cabin air system according to claim 1, further comprising:
a user interface, wherein the controller is configured to modulate at least one of the blower and the actuator in response to signals from the user interface.

5. The cabin air system according to claim 1, further comprising:
a sensor configured to sense at least one of temperature and humidity, wherein the controller is configured to modulate at least one of the blower and the actuator in response to signals from the sensor.

6. The cabin air system according to claim 1, further comprising:
a second face of the damper having an equal and opposite curvature to the first face of the damper, wherein the damper includes a teardrop shape configured to facilitate a smooth flow of air along the damper.

7. The cabin air system according to claim 2, further comprising:
a gasket disposed between the filter and the damper box;
a filter cover configured to retain the filter on the damper box; and
a lip disposed about the filter cover configured to mate with a corresponding lip on the gasket to generate a seal between the filter and the damper box.

8. A cabin air system, comprising:
a blower to generate a flow of air;
a damper box including:
a top portion and a bottom portion, both the top portion and the bottom portion being pie shaped as defined by a curved edge, a first straight edge and a second straight edge, the first straight edge and the second straight edge each having an end meeting at an angle and each straight edge having another end meeting respective ends of the curved edge;
a curved wall having a curved top edge joined to the curved edge of the top portion and the curved wall having a curved bottom edge joined to the curved edge of the bottom portion, the curved wall having an outside surface and an inside surface, the curved wall including a separator sandwiched between an outside air inlet and a recirculated air inlet;
a side wall having a first side edge joined to a first side edge of the curved wall, the side wall having a top edge joined to the first straight edge of the top portion, the side wall having a bottom edge joined to the first straight edge of the bottom portion; and
an outlet defined by a second side edge of the curved wall, the second straight edge of the top portion, the second straight edge of the bottom portion, and a second side edge of the side wall; and
a controller to control the blower.

9. The cabin air system according to claim 8, further comprising:
a damper having an axis of rotation adjacent to and in alignment with the separator, the damper having a first face and a trailing edge, the first face being curved and configured to mate with a curved frame disposed about the outside air inlet, the trailing edge being configured to mate with the side wall, wherein a ratio of outside air to recirculated air is modulated in response to the damper being rotated; and
an actuator configured to rotate the damper about the axis of rotation, wherein the controller is configured to control the actuator.

10. The cabin air system according to claim 9, further comprising:
a second face of the damper having an equal and opposite curvature to the first face of the damper, wherein the damper includes a teardrop shape configured to facilitate a smooth flow of air along the damper.

11. The cabin air system according to claim 8, further comprising:
a filter having a curvature matching the curved wall and covering the outside surface of the curved wall, the filter including:
an outside air portion configured to filter outside air; and
a recirculated air portion configured to filter recirculated air.

12. The cabin air system according to claim 11, further comprising:
a divider disposed in the filter between the outside air portion and the recirculated air portion and configured to reduce an amount of fluid exchange between the outside air portion and the recirculated air portion.

13. The cabin air system according to claim 9, further comprising:
a user interface, wherein the controller is configured to modulate at least one of the blower and the actuator in response to signals from the user interface.

14. The cabin air system according to claim 9, further comprising:
a sensor configured to sense at least one of temperature and humidity, wherein the controller is configured to modulate at least one of the blower and the actuator in response to signals from the sensor.

15. A method of filtering cabin air of a vehicle, the method comprising the steps of:
generating a flow of air through a damper box with a blower, the a damper box including:
a top portion and a bottom portion, both the top portion and the bottom portion being pie shaped as defined by a curved edge, a first straight edge and a second straight edge, the first and second straight edges each having an end meeting at an angle and each straight edge having another end meeting respective ends of the curved edge;
a curved wall having a curved top edge joined to the curved edge of the top portion and the curved wall having a curved bottom edge joined to the curved edge of the bottom portion, the curved wall having an outside surface and an inside surface, the curved wall including a separator sandwiched between an outside air inlet and a recirculated air inlet;
a side wall having a first side edge joined to a first side edge of the curved wall, the side wall having a top edge joined to the first straight edge of the top portion, the side wall having a bottom edge joined to the first straight edge of the bottom portion;
an outlet defined by a second side edge of the curved wall, the second straight edge of the top portion, the second straight edge of the bottom portion, and a second side edge of the side wall; and
modulating a ratio of outside air to recirculated air in the flow of air with a damper, the damper having an axis of rotation adjacent to and in alignment with the separator, the damper having a first face and a trailing edge, the first face being curved and configured to mate with a curved frame disposed about the outside air inlet, the trailing edge being configured to mate with the side wall, wherein a ratio of outside air to recirculated air is modulated in response to the damper being rotated.

16. The method according to claim 15, further comprising the step of:
filtering the flow of air with a filter, the filter having a curvature matching the curved wall and covering the outside surface of the curved wall, the filter including:
an outside air portion configured to filter outside air; and
a recirculated air portion configured to filter recirculated air.

17. The method according to claim 16, further comprising the step of:
dividing the filter with a divider, the divider being disposed in the filter between the outside air portion and the recirculated air portion and configured to reduce an amount of fluid exchange between the outside air portion and the recirculated air portion.

18. The method according to claim 15, further comprising the step of:
controlling at least one of the blower and the damper in response to signals from a user interface.

19. The method according to claim 18, further comprising the step of:
modulating a temperature of the flow of air with a heating ventilation air conditioning unit (HVAC) in response to signals for the user interface.

20. The method according to claim 15, further comprising the step of:
controlling at least one of the blower and the damper in response to signals from a sensor.
